(19) United States
(12) Patent Application Publication
(10) Pub. No.: US 2025/0181723 A1
(43) Pub. Date: Jun. 5, 2025

(54) APPARATUS FOR VERIFYING SECURITY GOAL FOR VEHICLE CYBERSECURITY AND A METHOD FOR THE SAME

(71) Applicants: HYUNDAI MOTOR COMPANY, Seoul (KR); KIA CORPORATION, Seoul (KR)

(72) Inventor: Kwon Hyeong Lee, Ansan-si (KR)

(73) Assignees: HYUNDAI MOTOR COMPANY, Seoul (KR); KIA CORPORATION, Seoul (KR)

(21) Appl. No.: 18/753,919

(22) Filed: Jun. 25, 2024

(30) Foreign Application Priority Data
Nov. 30, 2023 (KR) 10-2023-0171460

(51) Int. Cl. G06F 21/57; G06F 21/55; G06F 21/56

(52) U.S. Cl. CPC G06F 21/577; G06F 21/552; G06F 21/566

(57) ABSTRACT

An apparatus for verifying a security goal for vehicle cybersecurity includes an input device configured to receive a user input. The apparatus also includes a processor configured to derive a security goal linked to threat mitigation information by performing Threat Analysis Risk Assessment (TARA). The processor may also be configured to re-calculate an Attack Feasibility Rating based on assumption information corresponding to the security goal linked to the threat mitigation information, when entering into a mode TARA (ReCAL of re-executing the Threat Analysis Risk Assessment to verify completeness of the security goal.

### CROSS-REFERENCE TO RELATED APPLICATION

This application claims the benefit of and priority to Korean Patent Application No. 10-2023-0171460, filed on Nov. 30, 2023, the entire contents of which are hereby incorporated herein by reference.

### TECHNICAL FIELD

The present disclosure relates to an apparatus for verifying a security goal for vehicle cybersecurity and a method for the same.

### BACKGROUND

As the number of electronic control devices in a vehicle has increased, and as the vehicle communicates with the outside for over-the-air (OTA) updates, the cybersecurity vulnerabilities and threats such as illegal control of the vehicle and privacy infringement have also increased. Securing automobile security has become not optional, because the damage of hacking, such as a cyberattack on a vehicle, may cause a life accident that leads to death in the worst case scenario.

To develop a vehicle secured in security, both functional safety and cybersecurity have to be performed at the concept stage. The functional safety may be performed by analyzing a disaster factor and assessing a risk, and the cybersecurity may be performed through Threat Analysis Risk Assessment (TARA).

UNECE, which is an organization under the European Economic Commission, recommends requirements including TARA through UNR-155, which is a vehicle cybersecurity law. Further, ISO, which is an international standard agency, presents various requirements related to cybersecurity through ISO/SAE 21434 serving as a vehicle cybersecurity standard to analyze the threat to a vehicle controller based on the requirements in ISO/SAE 21434 international standards and UN-R155 laws.

When TARA is performed and a security goal is derived through the TARA, it is necessary to determine whether the security goal is appropriate to mitigate the threat of cybersecurity and whether that a residual threat exists. To this end, the TARA needs to be re-executed (TARA ReCAL).

The statements in this section merely provide background information related to the present disclosure and may not constitute prior art.

### SUMMARY

The present disclosure has been made to solve the above-mentioned problems occurring in the prior art while advantages achieved by the prior art are maintained intact.

Aspects of the present disclosure provide an apparatus and a method for verifying a security goal for vehicle cybersecurity, capable of applying assumption information to each threat for each attack path depending on a threat scenario, when TARA (ReCAL) is re-executed. The apparatus and method may thus reduce the time it takes to verify the security goal because the assumption information is not individually input for each threat depending on the threat scenario whenever the TARA is re-executed.

Aspects of the present disclosure provide an apparatus and a method for verifying a security goal for vehicle cybersecurity, capable of adding the security goal, derived by performing an initial TARA in an item definition stage during the re-execution of the TARA, to Assumption information. The apparatus and method are also capable of defining Assumption information, that is added in the step of defining the item, to each threat for each attack path depending on the threat scenario, such that a resource is ensured.

Aspects of the present disclosure provide an apparatus and a for verifying a security goal for vehicle cybersecurity, capable of re-calculating an attack feasibility rating derived through the initial TARA based on Assumption information applied to each threat for the attack path depending on the threat scenario to reduce the attack feasibility.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an apparatus for verifying a security goal for vehicle cybersecurity is provided. The apparatus includes an input device configured to receive an input of a user. The apparatus also includes a processor configured to derive a security goal linked to threat mitigation information by performing Threat Analysis Risk Assessment (TARA). The processor is also configured to re-calculate an Attack Feasibility Rating, based on assumption information corresponding to the security goal linked to the threat mitigation information, when entering into a mode TARA (ReCAL) of re-executing the Threat Analysis Risk Assessment to verify completeness of the security goal.

According to an embodiment, the processor may be configured to add the security goal as the assumption information, when defining an item after entering into the mode TARA (ReCAL of re-executing the Threat Analysis Risk Assessment, and in response to receiving, from a user, the security goal serving as the assumption information.

According to an embodiment, the processor may be configured to generate mapping information by mapping, based on a pre-stored database, i) threat mitigation information, derived with respect to each threat, among one or more threats, for each attack path, among one or more attack paths, depending on a threat scenario to ii) treatment mitigation information linked to the security goal.

According to an embodiment, the processor may be configured to extract the threat mitigation information mapped to the threat mitigation information derived with respect to each threat, among the one or more threats, based on the mapping information and linked to the security goal. The processor may also be configured to apply the assumption information corresponding to the security goal linked to the extracted threat mitigation information to the treatment mitigation information derived with respect to each threat among the one or more threats.

According to an embodiment, the processor may be configured to, when the Attack Feasibility Rating is re-calculated, re-determine a risk value based on the re-calculated Attack Feasibility Rating.

According to an embodiment, the processor may be configured to determine a risk treatment scheme, based on the re-determined risk value.

According to an embodiment, the processor may be configured to determine whether the risk treatment scheme is a scheme of Risk Acceptable.

According to an embodiment, the processor may be configured to, when the risk treatment scheme is determined as “Risk Acceptable”, determine completeness of the security goal as being verified.

According to an embodiment, the processor may be configured to generate a result of verification completed, when the completeness of the security goal is determined as being verified. The processor may also be configured to output the result of the verification completed through an output device.

According to an embodiment, the apparatus may further include a memory including the pre-stored database.

According to another aspect of the present disclosure, a method for verifying a security goal for vehicle cybersecurity is provided. The method includes deriving a security goal linked to threat mitigation information by performing Threat Analysis Risk Assessment (TARA). The method also includes re-calculating attack feasibility rating, based on assumption information corresponding to the security goal linked to the threat mitigation information, when entering into a mode TARA (ReCAL) of re-executing the Threat Analysis Risk Assessment to verify completeness of the security goal.

According to an embodiment, the method may further include adding the security goal as the assumption information, when defining an item after entering into the mode TARA (ReCAL) of re-executing the Threat Analysis Risk Assessment, and in response to receiving, from a user, the security goal serving as the assumption information.

According to an embodiment, the method may further include generating mapping information by mapping, based on a pre-stored database, i) threat mitigation information, derived with respect to each threat, among one or more threats, for each attack path, among one or more attack paths, depending on a threat scenario to ii) treatment mitigation information linked to the security goal.

According to an embodiment, the method may further include extracting the threat mitigation information mapped to the threat mitigation information derived with respect to each threat, among the one or more threats, based on the mapping information and linked to the security goal. The method may additionally include applying the assumption information corresponding to the security goal linked to the extracted threat mitigation information to the treatment mitigation information derived with respect to each threat among the one or more threats.

According to an embodiment, the method may further include, when the attack feasibility rating is re-calculated, re-determining a risk value based on the re-calculated attack feasibility rating.

According to an embodiment, the method may further include determining a risk treatment scheme based on the re-determined risk value.

According to an embodiment, the method may further include determining whether the risk treatment scheme is a scheme of Risk Acceptable.

According to an embodiment, the method may further include, when the risk treatment scheme is determined as Risk Acceptable, determining completeness of the security goal as being verified.

According to an embodiment, the method may further include generating a result of verification completed, when the completeness of the security goal is determined as being verified. The method may also include outputting the result of the verification completed through an output device.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating an apparatus for verifying a security goal for vehicle cybersecurity, according to an embodiment of the present disclosure;

FIG. 2 is a schematically illustrating a security goal derived, according to an embodiment of the present disclosure;

FIG. 3 is a view schematically illustrating the definition of an item, which performed by entering into a mode of re-executing TARA;

FIG. 4 is a view schematically illustrating an operation for analyzing an attack path, according to an embodiment of the present disclosure;

FIG. 5 is a block diagram illustrating a method for verifying a security goal for vehicle cybersecurity according to an embodiment of the present disclosure; and

FIG. 6 is a view illustrating the configuration of a computing system that may execute a method according to an embodiment of the present disclosure.

### DETAILED DESCRIPTION

Hereinafter, embodiments of the present disclosure are described in detail with reference to accompanying drawings. In adding the reference numerals to the components of each drawing, it should be noted that the identical or equivalent components are designated by the identical numerals even when the components are displayed on different drawings. In addition, in the following description, a detailed description of well-known features or functions has been omitted where it was determined that the detailed description would unnecessarily obscure the gist of the present disclosure.

In describing the components of the embodiments according to the present disclosure, terms such as first, second, “A”, “B”, “(a)”, “(b)”, and the like may be used. These terms are merely intended to distinguish one component from another component. the terms do not limit the nature, sequence, or order of the constituent components. Unless otherwise defined, all terms used herein, including technical or scientific terms, have the same or equivalent meanings as those generally understood by those having ordinary skill in the art to which the present disclosure pertains. Such terms as those defined in a generally used dictionary should be interpreted as having meanings that are consistent with their meanings in the relevant field of art, and should not be interpreted as having ideal or excessively formal meanings unless clearly defined as having such in the present disclosure.

When a component, device, element, or the like of the present disclosure is described as having a purpose or performing an operation, function, or the like, the component, device, or element should be considered herein as being “configured to” meet that purpose or perform that operation or function.

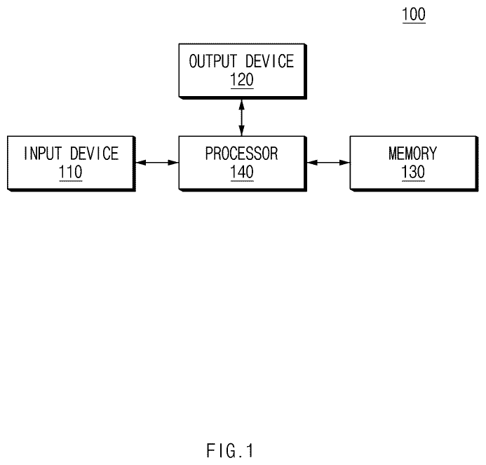

FIG. 1 is a block diagram illustrating an apparatus for verifying a security goal for vehicle cybersecurity, according to an embodiment of the present disclosure.

As illustrated in FIG. 1, an apparatus 100 for verifying a security goal for vehicle cybersecurity may include an input device 110, an output device 120, a memory 130, and a processor 140.

The input device 110 may receive an input corresponding to a touch, a motion, or a voice of a user (e.g., vehicle designer) and may transmit the input to the processor 140. The processor 140 may control an operation of verifying the security goal for vehicle cybersecurity to correspond to the input information. According to an embodiment, the input device 110 may include a touch-type input device or a mechanical input device. For example, the input device 110 may include a touch screen and/or may include a keyboard having characters or numbers arranged thereon.

The output device 120 may output a processing result (determination result) in the form of an image or a sound under the control of the processor 140. According to an embodiment, the output device 120 may be implemented in the form of a display device and/or a sound output device. The display device may include a head up display (HUD) or cluster. According to an embodiment, the display device may be a display that employs a liquid crystal display (LCD) panel, a light emitting diode (LED) panel, an organic light emitting diode (OLED) panel, or a plasma display panel (PDP). The LCD may include a thin film transistor-LCD (TFT-LCD). The display device may be integrally implemented with the input device 110 through a touch screen panel (TSP)

The memory 130 may store at least one algorithm to compute or execute various instructions for the operation of the apparatus for verifying the security goal for the vehicle cybersecurity according to an embodiment of the present disclosure. According to an embodiment, the memory 130 may store at least one instruction executed by the processor 140. The at least one instruction may allow the apparatus for verifying the security goal for the vehicle cybersecurity to operate according to an embodiment. The memory 150 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, and/or an optical disc.

According to an embodiment, the memory 130 may include a database (e.g., Threat Taxonomy Database). The database may include threat mitigation information (Mitigation) linked to each threat, among one or more threats, for each attack path, among the one or more attack paths, depending on threat scenarios. For example, the memory 130 may store threat mitigation information including an item for mitigating the threat with respect to each threat for each attack path to enable the processor 140 to derive the threat mitigation information for the each treat for each attack path depending on the threat scenarios based on the threat taxonomy database when re-executing TARA (TARA (ReCAL)). The threat mitigation information may include at least one of an Identification (ID) number for threat mitigation, a condition matched with the Identification (ID) number for threat mitigation, an instruction (a condition for mitigating the threat, or an instruction for mitigating the threat), or any combination thereof.

The processor 140 may be implemented by various processing devices, such as a microprocessor embedded therein with a semiconductor chip to operate or execute various instructions. The processor 140 may thus control the apparatus for verifying the security goal for the vehicle cybersecurity according to an embodiment. The processor 140 may be electrically connected to the input device 110, the output device 120, and the memory 130 through a wired cable or various circuits to transmit an electrical signal including a control command to execute an arithmetic operation or data processing related to a control operation and/or communication. The processor 140 may include at least one of a central processing unit, an application processor, a communication processor (CP), or any combination thereof.

The processor 140 may derive a security goal linked to the threat mitigation information (Mitigation) by performing Threat Analysis Risk Assessment (TARA).

In an embodiment, the Threat Analysis Risk Assessment (TARA) may be performed in sequence of (1) Item Definition, (2) Asset Identification, (3) Damage Scenario Identification, (4) Impact Rating, (5) Threat Scenario Identification, (6) Attack Path Analysis, (7) Attack Feasibility Rating, (8) Risk Value Determination, (9) Risk Treatment, or (10) Cybersecurity Goals Specify.

According to an embodiment, the processor 140 may derive the security goal linked to the threat mitigation information based on the database (Threat Taxonomy Database) stored in the memory 130.

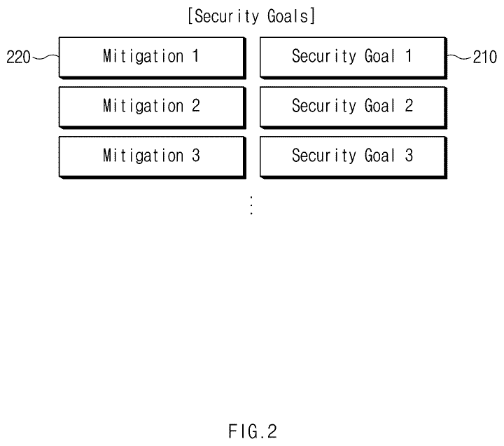

In an embodiment, the database may add detailed information (Asset Type (Detail)) about an asset type, information about an attack contact point (Attack Surface), and information about a target controller (ECU) requiring security to a vehicle's treat list, such that the processor 140 may classify the attack path in detail based on the database. In addition, since the database has the threat mitigation information (Mitigation) linked to each threat for each attack path, the processor 140 may derive the security goal linked to the threat mitigation information. The details thereof, according to an embodiment, are described below with reference to FIG. 2.

FIG. 2 is a schematically illustrating a security goal derived, according to an embodiment of the present disclosure.

As illustrated in FIG. 2, the processor 140 may derive a security goal 210 linked to threat mitigation information 220.

Referring back to FIG. 1, when driving the security goal linked to threat mitigation information, the processor 140 may enter into a mode (TARA (ReCAL)) of re-executing the Threat Analysis Risk Assessment to verify the completeness of the security goal. In other words, the processor 140 may enter into the mode (TARA (ReCAL)) of re-executing Threat Analysis Risk Assessment to determine whether the risk resulting from the threat is acceptable through the security goal.

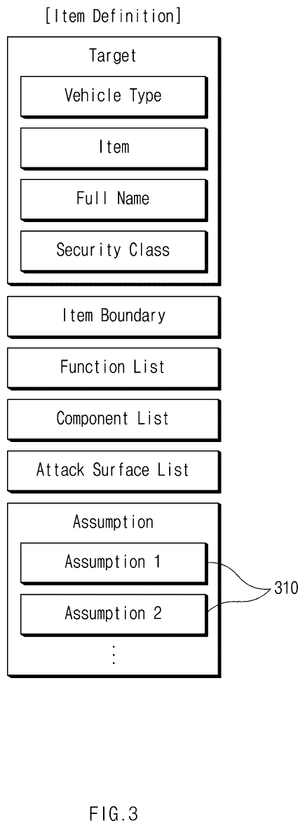

According to an embodiment, the processor 140 may perform (1) item definition by entering into the mode (TARA (ReCAL)) of re-executing the Threat Analysis Risk Assessment. The details thereof, according to an embodiment, are described below with reference to FIG. 3.

FIG. 3 is a view schematically illustrating the definition of an item that may be performed by entering into the mode (TARA (ReCAL)) of re-executing the Threat Analysis Risk Assessment according to an embodiment of the present disclosure.

As illustrated in FIG. 3, the processor 140 may acquire basic information for executing the Threat Analysis Risk Assessment (TARA) based on information about an item serving as the target of the Threat Analysis Risk Assessment (TARA). In this case, the item may refer to a component or a bundle of components to perform a function in the vehicle. According to an embodiment, the item may include a controller to perform the function in the vehicle.

According to an embodiment, the processor 140 may identify information of a target item, including a vehicle type, an item, a full name, and a security class. The processor 140 may define information directly related to the target item in an item boundary region. The processor 140 may acquire information input into a function list, a component list, or an attack surface list.

In addition, the processor 140 may receive information for assuming that the risk resulting from the threat is acceptable through the security goal, from the user. According to an embodiment, the processor 140 may add the security goal to assumption information 310 in response to receiving, from the user, the information for assuming that the risk resulting from the threat is acceptable through the security goal.

Referring back to FIG. 1, when an operation for defining (Item Definition) an item is performed, the processor 140 may additionally re-perform (2) Asset Identification, (3) Damage Scenario Identification, (4) Impact Rating, and (5) Threat Scenario Identification.

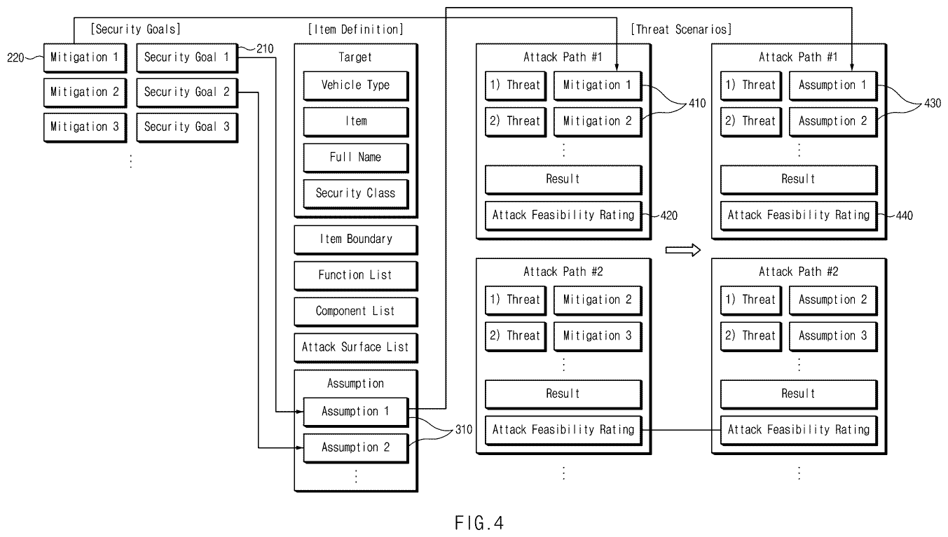

The processor 140 may analyze an attack path of the threat scenario. The details thereof, according to an embodiment, are described below with reference to FIG. 4.

FIG. 4 is a view schematically illustrating the operation for analyzing an attack path, according to an embodiment of the present disclosure.

As illustrated in FIG. 4, the processor 140 may generate mapping information by mapping threat mitigation information 410 derived from the database with respect to each threat for each attack path depending on the threat scenarios to treat mitigation information 220 linked to the security goal.

According to an embodiment, the processor 140 may map threat mitigation information (Mitigation 1) derived from the database with respect to each threat for each attack path depending on the threat scenarios to threat mitigation information (Mitigation 1) linked to the security goal and may generate the mapping information.

The processor 140 may extract the threat mitigation information 220 mapped to the threat mitigation information 410 derived with respect to each threat, based on the mapping information, and may apply the assumption information 310 corresponding to the security goal 210 linked to the extracted threat mitigation information 220 to the treat mitigation information derived with respect to each threat. Accordingly, the processor 140 may link the assumption information 430 to each threat, based on the mapping information.

The processor 140 may re-calculate Attack Feasibility Rating 440 when the assumption information 430 is linked to each threat based on the mapping information.

Referring back to FIG. 1, the processor 140 may re-determine a risk value based on the re-calculated Attack Feasibility Rating 440. According to an embodiment, the processor 140 may classify the Attack Feasibility Rating 440 into “Very Low”, “Low”, “Medium”, or “High”, and may re-determine a risk level by considering the Attack Feasibility Rating and the impact rating of damage scenario.

The processor 140 may determine a risk treatment scheme resulting from a threat, based on the re-determined risk level. According to an embodiment, the processor 140 may define a risk value ranging from Risk value 1 to Risk value 5. For Risk value 1, the risk treatment scheme resulting from the threat may be determined as “Risk Acceptable”. In this case, “Risk Acceptable” may signify that a present threat is maintained, without additional risk reduction treatment.

The processor 140 may determine the completeness of the security goal as being verified, when the risk treatment scheme resulting from the threat is determined as “Risk Acceptable”. The processor 140 may control to generate the result of verification completed, when the completeness of the security goal is determined as being verified, and to output the result of the verification completed through the output device 120.

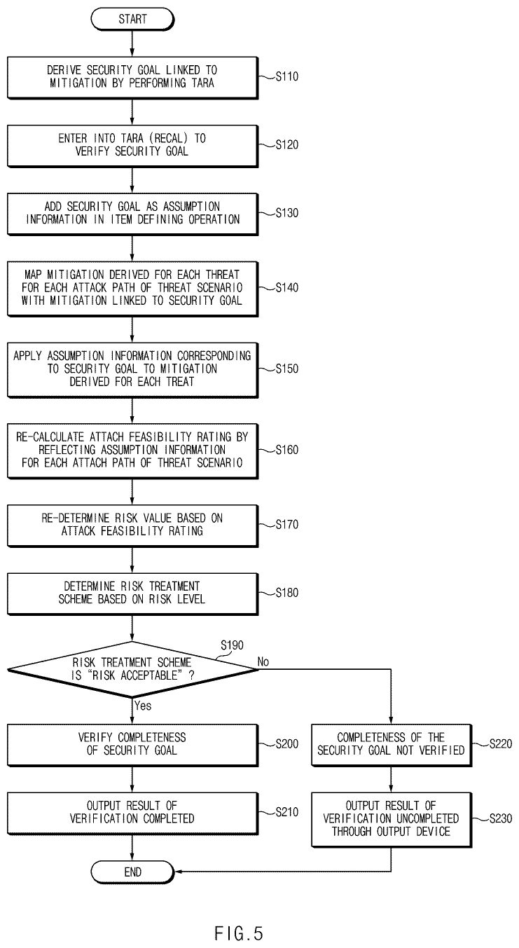

FIG. 5 is a block diagram illustrating a method for verifying a security goal for vehicle cybersecurity, according to an embodiment of the present disclosure.

In an operation S110, the processor 140 may derive a security goal linked to the threat mitigation information (Mitigation) by performing Threat Analysis Risk Assessment (TARA).

In an embodiment, the Threat Analysis Risk Assessment (TARA) may be performed in sequence of (1) item definition, (2) Asset Identification, (3) Damage Scenario Identification, (4) Impact Rating, (5) Threat Scenario Identification, (6) Attack Path Analysis, (7) Attack Feasibility Rating, (8) Risk Value Determination, (9) Risk Treatment, or (10) Cybersecurity Goals Specify.

According to an embodiment, the processor 140 may derive the security goal linked to the threat mitigation information based on the database (Threat Taxonomy Database) stored in the memory 130.

In an embodiment, the database may additionally have detailed information about an asset type (Asset Type (Detail)), information about a target controller (ECU), a remaining ECU of a vehicle, and/or an interface of the remaining ECU to a vehicle's threat list. Accordingly, the processor 140 may classify the attack path in detail based on the database. In addition, since the database has the threat mitigation information (Mitigation) linked to each threat for each attack path depending on the threat scenarios, the processor 140 may derive the security goal linked to the threat mitigation information.

When driving the security goal linked to threat mitigation information, the processor 140 may, in an operation S120, enter into the mode (TARA (ReCAL)) of re-executing the Threat Analysis Risk Assessment to verify the completeness of the security goal. In other words, the processor 140 may enter into the mode (TARA (ReCAL)) of re-executing the Threat Analysis Risk Assessment to determine whether the risk resulting from the threat is acceptable through the security goal.

According to an embodiment, the processor 140 may enter into the mode for re-executing the Threat Analysis Risk Assessment (TARA (ReCAL)) to (1) perform “Item Definition”. The processor 140 may receive, from the user, information for assuming that the risk resulting from the threat is acceptable through the security goal, in the operation of “Item Definition”. According to an embodiment, in an operation S130, the processor 140 may add the security goal as assumption information 310 when receiving, from the user, the security goal as assumption information.

When the operation of “Item Definition” is performed, the processor 140 may additionally re-perform (2) Asset Identification, (3) Damage Scenario Identification, (4) Impact Rating, and (5) Threat Scenario Identification.

The processor 140 may analyze an attack path of the threat scenario.

The processor 140 may generate mapping information by mapping threat mitigation information 410 derived from the database with respect to each threat for each attack path depending on the threat scenarios to treat mitigation information 220 linked to the security goal.

According to an embodiment, the processor 140 may map threat mitigation information (Mitigation 1) derived with respect to each threat for each attack path depending on the threat scenarios to threat mitigation information (Mitigation 1) linked to the security goal, for example as illustrated in FIG. 4.

The processor 140 may extract the threat mitigation information 220 mapped to the threat mitigation information 410 derived with respect to each threat, based on the mapping information. In an operation S150, the processor 140 may apply the assumption information 310 corresponding to the security goal 210 linked to the extracted threat mitigation information 220 to the treat mitigation information derived with respect to each threat. Accordingly, the processor 140 may link the assumption information 430 to each threat based on the mapping information, for example as illustrated in FIG. 4.

In an operation S160, the processor 140 may re-calculate Attack Feasibility Rating 440, when the assumption information 430 is linked to each threat based on the mapping information.

In an operation S170, the processor 140 may re-determine a risk value based on the re-calculated Attack Feasibility Rating 440. According to an embodiment, the processor 140 may classify the Attack Feasibility Rating into “Very Low”, “Low”, “Medium”, or “High”. The processor 140 may re-determine a risk level by considering the Attack Feasibility Rating and the impact rating of damage scenario.

In an operation S180, the processor 140 may determine a risk treatment scheme resulting from a threat, based on the re-determined risk level.

In an operation S190, the processor 140 may determine whether the risk treatment scheme from the threat is “Risk Acceptable”. According to an embodiment, the processor 140 may define a risk value ranging from Risk value 1 to Risk value 5. For Risk value 1, the risk treatment scheme resulting from the threat may be determined as “Risk Acceptable”. In this case, “Risk Acceptable” may signify that a present threat is maintained, without additional risk reduction treatment.

In an operation S200, the processor 140 may determine the completeness of the security goal as being verified, when the risk treatment scheme resulting from the threat is determined as “Risk Acceptable”.

In an operation S210, the processor 140 may control to generate the result of verification when the completeness of the security goal is determined as being verified. The processor may output the result of the verification completed through the output device 120.

In an embodiment, when the risk value is any value in the range of Risk value 1 to Risk value 5, the processor 140 may determine that the risk treatment scheme from the threat is not ‘Risk acceptable’, and may, in an operation S220, determine that the completeness of the security goal is not verified. The processor 140 may generate the result of verification uncompleted, and, in an operation S230, may output the result of verification uncompleted through the output device 120.

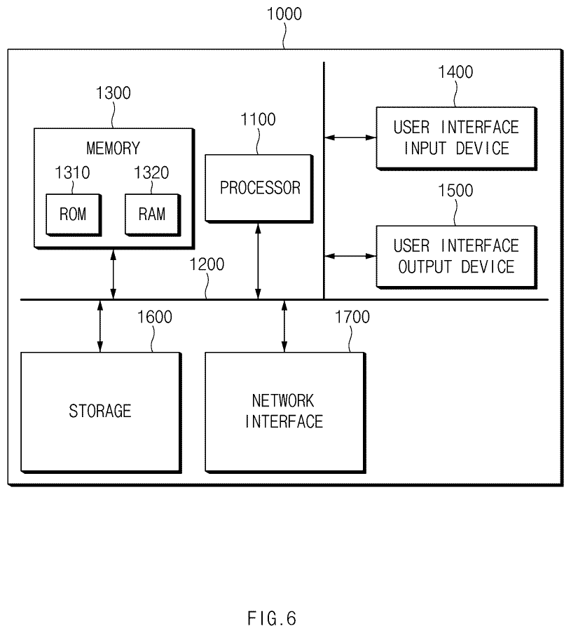

FIG. 6 is a view illustrating the configuration of a computing system to execute a method, according to an embodiment of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the embodiments of the present disclosure may be directly implemented with a hardware module, a software module, or any combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to an embodiment of the present disclosure, in the apparatus for verifying the security goal for vehicle cybersecurity and the method for the same, the assumption information may be applied to each threat for each attack path depending on the threat scenario when TARA (ReCAL) is re-executed, thereby saving the time taken to verify the security goal, as the assumption information is not individually input for each threat depending on the threat scenario, whenever the TARA is re-executed.

According to an embodiment of the present disclosure, in the apparatus for verifying the security goal for vehicle cybersecurity and the method for the same, the security goal, that is derived by performing an initial TARA in an item definition stage during the re-execution of the TARA, may be added to Assumption information. Further, the Assumption information, that is added in the step of defining the item, may be applied to each threat for each attack path depending on the threat scenario, such that the resource is ensured. In addition, according to an embodiment of the present disclosure, in the apparatus for verifying the security goal for vehicle cybersecurity and the method for the same, the attack feasibility rating derived through the initial TARA may be re-calculated based on Assumption information applied to each threat for the attack path depending on the threat scenario to reduce the attack feasibility.

The above description is merely illustrative of the technical idea of the present disclosure, and various modifications and alterations may be made by one having ordinary skill in the art without departing from the essential characteristic of the present disclosure.

Therefore, the described embodiments of the present disclosure are provided to explain the spirit and scope of the present disclosure, but not to limit them. The spirit and scope of the present disclosure is not limited by the described embodiments. The scope of the present disclosure should be construed on the basis of the accompanying claims, and all the technical ideas within the scope equivalent to the claims should be included in the scope of the present disclosure.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. An apparatus for verifying a security goal for vehicle cybersecurity, the apparatus comprising:
an input device configured to receive an input of a user; and
a processor configured to
derive a security goal linked to threat mitigation information by performing Threat Analysis Risk Assessment (TARA), and
re-calculate an Attack Feasibility Rating, based on assumption information corresponding to the security goal linked to the threat mitigation information, when entering into a mode TARA (ReCAL) of re-executing the Threat Analysis Risk Assessment to verify completeness of the security goal.

2. The apparatus of claim 1, wherein the processor is configured to add the security goal as the assumption information, when defining an item after entering into the mode TARA (ReCAL) of re-executing the Threat Analysis Risk Assessment, and in response to receiving, from the user, the security goal serving as the assumption information.

3. The apparatus of claim 1, wherein the processor is configured to generate mapping information by mapping, based on a pre-stored database, i) threat mitigation information, derived with respect to each threat, among one or more threats, for each attack path, among one or more attack paths, based on a threat scenario to ii) treatment mitigation information linked to the security goal.

4. The apparatus of claim 3, wherein the processor is configured to:
extract the threat mitigation information mapped to the threat mitigation information derived with respect to each threat, among the one or more threats, based on the mapping information and linked to the security goal; and
apply the assumption information corresponding to the security goal linked to the extracted threat mitigation information to the treatment mitigation information derived with respect to each threat among the one or more threats.

5. The apparatus of claim 1, wherein the processor is configured to, when the Attack Feasibility Rating is re-calculated, re-determine a risk value based on the re-calculated Attack Feasibility Rating.

6. The apparatus of claim 5, wherein the processor is configured to determine a risk treatment scheme based on the re-determined risk value.

7. The apparatus of claim 6, wherein the processor is configured to determine whether the risk treatment scheme is a scheme of Risk Acceptable.

8. The apparatus of claim 7, wherein the processor is configured to, when the risk treatment scheme is determined as Risk Acceptable, determine completeness of the security goal as being verified.

9. The apparatus of claim 8, wherein the processor is configured to:
generate a result of verification completed, when the completeness of the security goal is determined as being verified, and
output the result of the verification completed through an output device.

10. The apparatus of claim 3, further comprising a memory including the pre-stored database.

11. A method for verifying a security goal for vehicle cybersecurity, the method comprising:
deriving a security goal linked to threat mitigation information by performing Threat Analysis Risk Assessment (TARA); and
re-calculating an Attack Feasibility Rating, based on assumption information corresponding to the security goal linked to the threat mitigation information, when entering into a mode TARA (ReCAL) of re-executing the Threat Analysis Risk Assessment to verify completeness of the security goal.

12. The method of claim 11, further comprising adding the security goal as the assumption information, when defining an item after entering into the mode (TARA (ReCAL) of re-executing the Threat Analysis Risk Assessment, and in response to receiving, from a user, the security goal serving as the assumption information.

13. The method of claim 11, further comprising generating mapping information by mapping, based on a pre-stored database, i) threat mitigation information, derived with respect to each threat, among one or more threats, for each attack path, among one or more attack paths, depending on a threat scenario to ii) treatment mitigation information linked to the security goal.

14. The method of claim 13, further comprising:
extracting the threat mitigation information mapped to the threat mitigation information derived with respect to each threat, among the one or more threats, based on the mapping information and linked to the security goal; and
applying the assumption information corresponding to the security goal linked to the extracted threat mitigation information to the treatment mitigation information derived with respect to each threat among the one or more threats.

15. The method of claim 11, further comprising, when the Attack Feasibility Rating is re-calculated, re-determining a risk value based on the re-calculated Attack Feasibility Rating.

16. The method of claim 15, further comprising determining a risk treatment scheme based on the re-determined risk value.

17. The method of claim 16, further comprising determining whether the risk treatment scheme is a scheme of Risk Acceptable.

18. The method of claim 17, further comprising, when the risk treatment scheme is determined as Risk Acceptable, determining completeness of the security goal as being verified.

19. The method of claim 18, further comprising:
generating a result of verification completed, when the completeness of the security goal is determined as being verified, and
outputting the result of the verification completed through an output device.
